(19) United States
(12) Patent Application Publication
(10) Pub. No.: US 2022/0206502 A1
(43) Pub. Date: Jun. 30, 2022

(54) BLIND AREA ESTIMATION APPARATUS, VEHICLE TRAVEL SYSTEM, AND BLIND AREA ESTIMATION METHOD

(71) Applicant: Mitsubishi Electric Corporation, Tokyo (JP)

(72) Inventors: Haiyue ZHANG, Tokyo (JP); Toshihide SATAKE, Tokyo (JP); Toru HIGUCHI, Tokyo (JP); Hideyuki TANAKA, Tokyo (JP)

(73) Assignee: Mitsubishi Electric Corporation, Tokyo (JP)

(21) Appl. No.: 17/505,884

(22) Filed: Oct. 20, 2021

(30) Foreign Application Priority Data
Dec. 24, 2020 (JP) 2020-214993

(51) Int. Cl. G05D 1/02; G01C 21/00; G06K 9/00; G01C 21/10; G06K 9/62

(52) U.S. Cl. CPC G05D 1/0214; G01C 21/005; G05D 1/028; G05D 1/0278; G06K 9/6288; G06K 9/00805; G01C 21/10; G01C 21/3867; G01C 21/3893; G05D 1/0291

(57) ABSTRACT

An object is to provide a technique capable of estimating a blind area region which can be used in an automatic driving to optimize the automatic driving, for example. A blind area estimation device includes an acquisition part and an estimation part. The acquisition part acquires an object region based on object information. The object information is information of an object in a predetermined region detected by a detection part. The object region is a region of the object. The estimation part estimates a blind area region based on the object region. The blind area region is a region which is a blind area for the detection part caused by the object.

### BACKGROUND OF THE INVENTION

### Field of the Invention

The present disclosure relates to a blind area estimation apparatus, a vehicle travel system, and a blind area estimation method.

### Description of the Background Art

A conventional vehicle travel system grasps a position of an object in a predetermined region as object information by a road side unit (RSU) which is an apparatus disposed on a roadside and provides an automatic driving vehicle in the region with object information (for example, Japanese Patent Application Laid-Open No. 2020-37400). More specifically, a server processes the object information acquired by the RSU and transmits the processed object information to the automatic driving vehicle in the region. The automatic driving vehicle determines a traveling route in consideration of the object information, and travels based on the traveling route. According to such a configuration, even the automatic driving vehicle which does not include a sensor for detecting a surrounding environment can travel in the region with an automatic driving.

### SUMMARY

However, the RSU is provided to monitor a ground from a height in many cases, thus there is a region which cannot be detected due to shielding by an object on the ground, that is to say, a blind area region which is a blind area for the RSU caused by the object. As described above, when an obstacle is located in the blind area region of which the RSU cannot grasp a state, there is a possibility that an automatic driving vehicle traveling in the blind area region collides with the obstacle. Thus, a blind area region which can be used in an automatic driving, for example, is required.

The present disclosure is therefore has been made to solve problems as described above, and it is an object of the present disclosure to provide a technique capable of estimating a blind area region.

A blind area estimation device according to the present disclosure includes: an acquisition part acquiring an object region which is a region of an object based on object information which is information of the object in a predetermined region detected by a detection part; and an estimation part estimating a blind area region which is a region of a blind area for the detection part caused by the object based on the object region.

The blind area region can be estimated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing illustrating a vehicle travel system according to an embodiment 1.

FIG. 2 is a block diagram illustrating a configuration of an RSU according to the embodiment 1.

FIG. 3 is a drawing for describing a blind area generation mechanism caused by an object and a method of calculating the blind area region.

FIG. 4 is a drawing for describing a blind area generation mechanism caused by an object and a method of calculating the blind area region.

FIG. 5 is a drawing for describing the blind area region according to the embodiment 1.

FIG. 6 is a flow chart illustrating an operation of the RSU according to the embodiment 1.

FIG. 7 is a drawing illustrating transmission information from the RSU to a fusion server according to the embodiment 1.

FIG. 8 is a block diagram illustrating a configuration of the fusion server according to the embodiment 1.

FIG. 9 is a flow chart illustrating an operation of the fusion server according to the embodiment 1.

FIG. 10 is a drawing for describing an integration of a region performed by the fusion server according to the embodiment 1.

FIG. 11 is a drawing illustrating transmission information from the fusion server to an automatic driving vehicle according to the embodiment 1.

FIG. 12 is a block diagram illustrating a configuration of a vehicle-side control device according to the embodiment 1.

FIG. 13 is a flow chart illustrating an operation of the vehicle-side control device according to the embodiment 1.

FIG. 14 is a drawing for explaining an operation of the vehicle-side control device according to the embodiment 1.

FIG. 15 is a drawing for explaining an operation of the vehicle-side control device according to the embodiment 1.

FIG. 16 is a drawing for explaining an operation of the vehicle-side control device according to the embodiment 1.

FIG. 17 is a drawing for explaining an operation of the vehicle-side control device according to the embodiment 1.

FIG. 18 is a drawing for explaining an operation of the vehicle-side control device according to the embodiment 1.

FIG. 19 is a drawing illustrating a vehicle travel system according to an embodiment 2.

FIG. 20 is a block diagram illustrating a configuration of a route plan server according to the embodiment 2.

FIG. 21 is a drawing illustrating transmission information from the route plan server to the automatic driving vehicle according to the embodiment 2.

FIG. 22 is a flow chart illustrating an operation of the route plan server according to the embodiment 2.

FIG. 23 is a block diagram illustrating a configuration of a vehicle-side control device according to the embodiment 2.

FIG. 24 is a block diagram illustrating a hardware configuration of a blind area estimation device according to another modification example.

FIG. 25 is a block diagram illustrating a hardware configuration of a blind area estimation device according to another modification example.

### DESCRIPTION OF THE PREFERRED EMBODIMENTS

### Embodiment 1

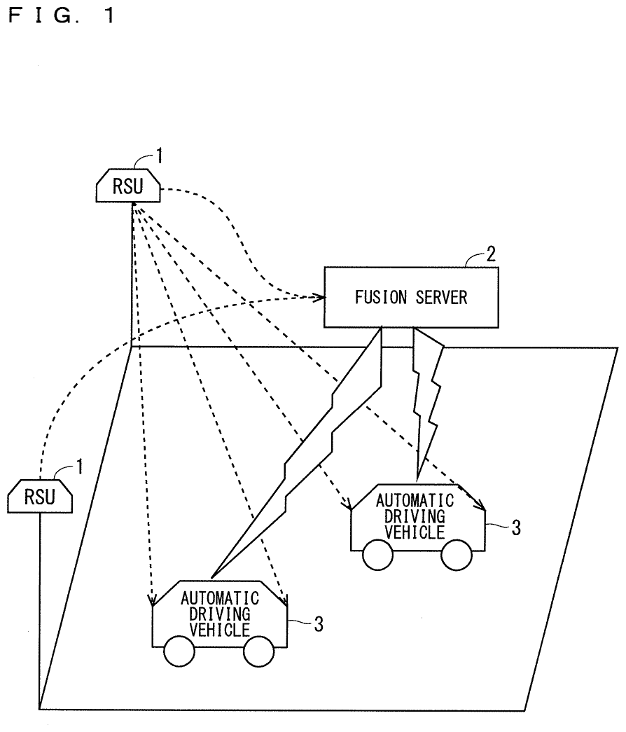

FIG. 1 is a drawing illustrating a vehicle travel system according to the present embodiment 1. The vehicle travel system in FIG. 1 includes a road side unit (RSU) 1, a fusion server 2, and an automatic driving vehicle 3.

The RSU 1 is a blind area estimation device, and generates an object region which is a region of an object in a predetermined region and a blind area region which is a region of a blind area for a detection part of the RSU 1 by the object as described hereinafter. In the present embodiment 1, the predetermined region is a region which is a target of generation of the object region and the blind area region by the RSU 1, that is to say, a generation target region, however, this configuration is not necessary. In the present embodiment 1, the plurality of RSUs 1 are directed to a plurality of directions, respectively, however, this configuration is not necessary, but only one RSU 1 may also be provided, for example.

The fusion server 2 generates an integrated object region and blind area region based on object regions and blind area regions generated by the plurality of RSUs 1. The automatic driving vehicle 3 determines a traveling route along which the automatic driving vehicle 3 should perform an automatic driving based on the integrated object region and blind area region generated by the fusion server 2. The automatic driving of the automatic driving vehicle 3 may be an automatic driving of autonomous driving (AD) control or an automatic driving of advanced driver assistance system (ADAS) control.

Configuration of RSU

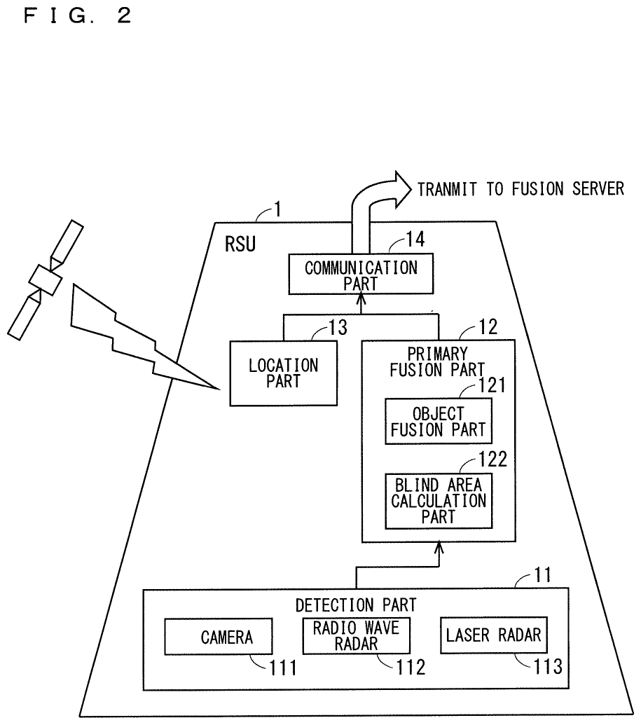

FIG. 2 is a block diagram illustrating a configuration of the RSU 1 according to the present embodiment 1. The RSU 1 in FIG. 2 includes a detection part 11, a primary fusion part 12, a location part 13, and a communication part 14.

The detection part 11 is made up of a sensor capable of detecting object information which is information of an object in the generation target region and a supporter circuit of the sensor. In the present embodiment 1, the sensor includes a camera 111, a radio wave radar 112, and a laser radar 113, and the object information is information corresponding to a detection result of the camera 111 the radio wave radar 112 and the laser radar 113. The object may be a moving object or a stationary object.

The primary fusion part 12 processes the object information detected by the detection part 11. The primary fusion part 12 includes an object fusion part 121 which is an acquisition part and a blind area calculation part 122 which is an estimation part. The object fusion part 121 acquires the object region which is the region of the object in the generation target region by calculation, for example, based on the object information detected by the detection part 11. The blind area calculation part 122 estimates the blind area region which is a region of a blind area for the detection part 11 caused by the object by calculation, for example, based on the calculated object region.

The location part 13 acquires a position of the RSU 1 and a direction (orientation, for example) of the RSU 1. The location part 13 is made up of a positioning module of global navigation satellite system (GNSS) such as a GPS, a quasi-zenith satellite such as Michibiki, Beidou, Galileo, GLONASS and a NAVIC and an orientation measurement means using an inertia principle such as a gyroscope, for example.

The communication part 14 transmits information of the object region and the blind area region of the primary fusion part 12 and information of a position and a direction of the RSU 1 of the location part 13 to the fusion server 2. The communication part 14 is made up of a general-purpose communication apparatus or a dedicated communication network apparatus, for example.

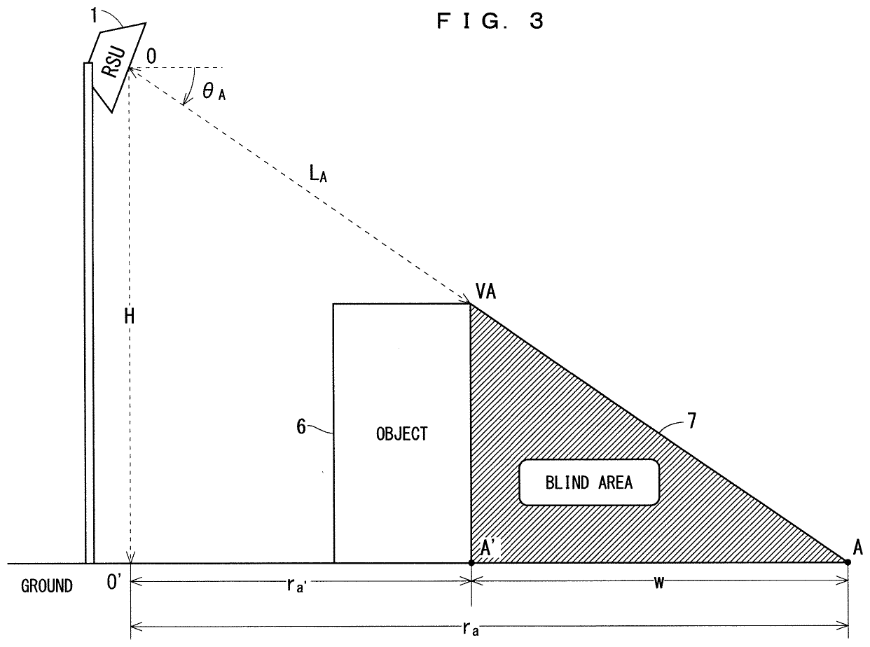

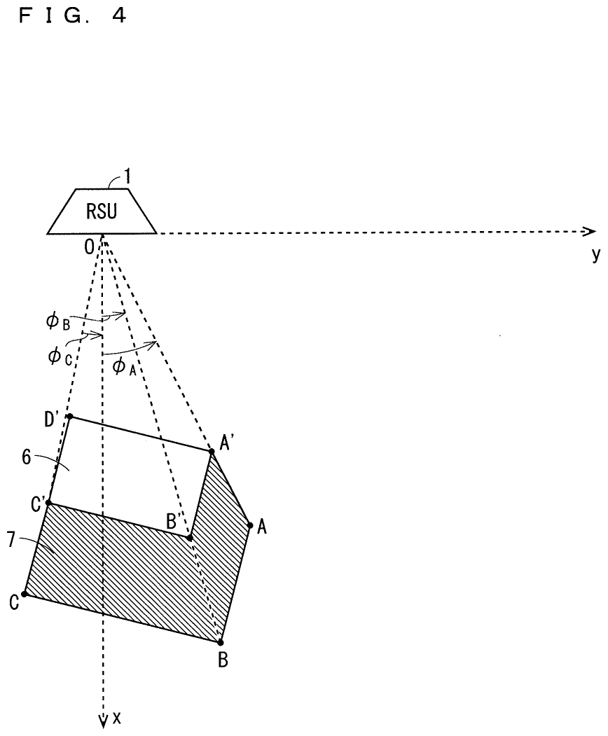

FIG. 3 and FIG. 4 are drawings for describing a blind area generation mechanism caused by an object and a method of calculating the blind area region. FIG. 3 is a drawing seen from a horizontal direction of a ground, and FIG. 4 is a drawing seen from a vertical direction of the ground (that is to say, a plan view). FIG. 3 and FIG. 4 illustrate an object 6 in the generation target region and a blind area 7 for the RSU 1 generated by the object 6. That is to say, FIG. 3 and FIG. 4 illustrate the object region which is the region of the object 6 detectable by the RSU 1 and the blind area region which is the region of the blind area 7 which is located on an opposite side of the object 6 from the RSU 1 and cannot detected by the RSU 1.

Herein, in FIG. 3, a placement reference point of the RSU 1 is indicated by O, a height of O from the ground is indicated by H, a distance from the RSU 1 to a corner VA of the object 6 on a distal side in cross section is indicated by L_{A}, and an angle between a segment between O and VA and the horizontal direction is indicated by θ_{A}. In this case, each of a distance ra from a most distal point A of the blind area 7 and a ground projection O′ of O, a distance ra′ from a distal side of the object 6 in cross section and a placement position of the RSU 1 along the ground, and a width w of a cross section of the blind area region along the ground can be calculated using the following equations (1), (2), and (3).

$$\begin{matrix}[ Math 1 ] & \\ {r}_{a} = \frac{H}{tan {θ}_{A}} & ( 1 ) \\ [ Math 2 ] & \\ {r}_{a}^{′} = {L}_{A} cos {θ}_{A} & ( 2 ) \\ [ Math 3 ] & \\ w = {r}_{a} - {r}_{a}^{′} = \frac{H}{tan {θ}_{A}} - {L}_{A} cos {θ}_{A} & ( 3 )\end{matrix}$$

Assuming that the object 6 has a quadrangular shape in FIG. 4, there is a blind area region surrounded by sides formed by projecting sides of the quadrangular shape based on a placement reference point O of the RSU 1. For example, in a case of FIG. 4, a blind area region caused by a side C′B′ of the object 6 is a region C′B′BC, and a blind area region caused by a side A′B′ is a region A′B′BA. A shape of each of the blind area region C′B′BC and the blind area region A′B′BA can approximate to a quadrangular shape. Thus, in the case of FIG. 4, the blind area region caused by the object 6 is a hexagonal region A′B′CBA formed by combining the blind area region C′B′BC and the blind area region A′B′BA. In this manner, the blind area region can be expressed by coordinates of corners A′, B′, and C′ of the object 6 and coordinates of points A, B, and C corresponding thereto.

Next, a calculation of the coordinates of the points A, B, and C is described. For example, assumed as illustrated in FIG. 4 is a plane coordinate system parallel to the ground with the placement reference point O of the RSU 1 as an origin point. The point A is located on an extended line of the placement reference point O and the point A′. When an angle between a straight line OA′A and an x axis is φ_{A}, a coordinate of A can be calculated using the following equation (4) and a coordinate of A′ can be calculated using the following equation (5). Coordinates of the points B, C, B′, and C′ can also be calculated in the manner similar to the coordinates of the points A and A′.

$$\begin{matrix}[ Math 4 ] & \\ ( {r}_{a} cos {ϕ}_{A} , {r}_{a} sin {ϕ}_{A} ) = ( \frac{H cos {ϕ}_{A}}{tan {θ}_{A}} , \frac{H sin {ϕ}_{A}}{tan {θ}_{A}} ) & ( 4 ) \\ [ Math 5 ] & \\ ( {r}_{a} \cdot cos {ϕ}_{A} , {r}_{a} \cdot sin {ϕ}_{A} ) = ( {L}_{A} cos {θ}_{A} cos {ϕ}_{A} , {L}_{A} cos {θ}_{A} sin {ϕ}_{A} ) & ( 5 )\end{matrix}$$

As described above, the blind area calculation part 122 applies the object region including L_{A}, θ_{A}, and φ_{A} of each point of the object 6 and a height H of the placement reference point O from the ground to the above equations (1) to (5) to estimate the blind area region. The height H may be a fixed value set at a time of placing the RSU 1 or a value appropriately detected by the detection part 11.

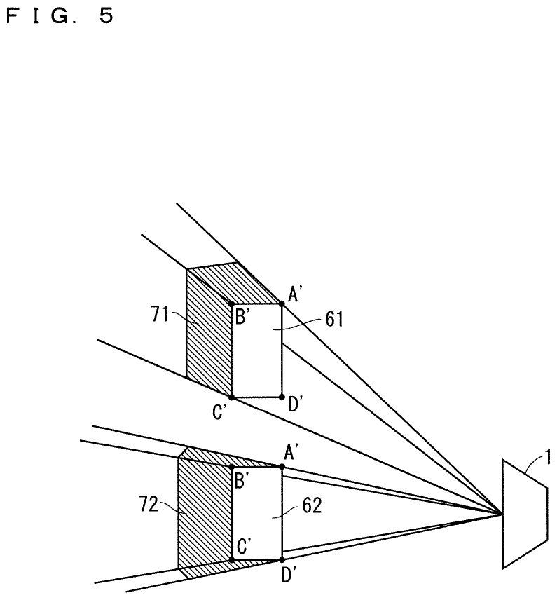

As illustrated in FIG. 5, a shape of the blind area region changes into a shape of combining two quadrangular shape and a shape of combining three quadrangular shape, for example, in accordance with a direction (for example, an orientation) of the object region of the object 6 with respect to the RSU 1. For example, in a case of a direction of an object region 61, a shape of a blind area region 71 is a hexagonal shape formed by combining two quadrangular shape, and in a case of a direction of the object region 62, a shape of a blind area region 72 is an octagon shape formed by combining three quadrangular shape. The blind area calculation part 122 can also estimate the octagon blind area region 72 in the manner similar to the hexagonal blind area region 71.

Flow chart of RSU

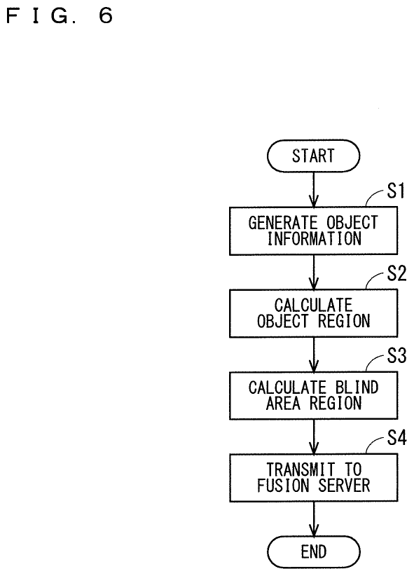

FIG. 6 is a flow chart illustrating an operation of the RSU 1 according to the present embodiment 1. The RSU 1 executes the operation illustrated in FIG. 6 every predetermined time period.

Firstly in Step S1, the detection part 11 takes in raw data of each sensor, and generates object information based on the raw data of each sensor. For example, the detection part 11 identifies the object 6 in a screen at a certain time from an image signal which is raw data of the camera 111 to generate a position and a direction of the object 6 as the object information. Then, the detection part 11 generates a point group which is raw data of the radio wave radar 112 and the laser radar 113 as the object information. When an output period of each sensor is different from each other, the detection part 11 synchronizes the data which is the output of each sensor.

In Step S2, the object fusion part 121 performs fusion processing of fusing the object information generated by the detection part 11 to calculate the object region. Used as the fusion processing is a known technique of preferentially using a value of a sensor having high reliability in consideration of reliability of each sensor in environment conditions of a temperature and light intensity when the different sensors detect values of the same item, for example. The object fusion part 121 may calculate not only the object region but also a speed and an acceleration rate of the object 6, for example.

In the present embodiment 1, the object fusion part 121 estimates whether the object 6 is a moving object or a stationary object in Step S2. That is to say, the object fusion part 121 estimates whether the blind area region estimated in the following Step S3 is a region which is a region of a blind area caused by a moving object or a region which is a region of a blind area caused by a stationary object. For example, the object fusion part 121 estimates that the object 6 is a moving object when a suspension time of the object 6 is equal to or smaller than a threshold value, and estimates that the object 6 is a stationary object when a suspension time of the object 6 is larger than the threshold value. The other constituent element (for example, the blind area calculation part 122) of the primary fusion part 12 may estimate whether a region is a blind area caused by a moving object or a stationary object.

In Step S3, the blind area calculation part 122 calculates the blind area region using the above calculation methods described in FIG. 3 and FIG. 4 based on the object region calculated by the object fusion part 121.

In Step S4, the communication part 14 transmits, to the fusion server 2, the information of the object region and the blind area region, the estimation result indicating whether the object 6 is the moving object or the stationary object, and the information of the position and the direction of the RSU 1 of the location part 13. Subsequently, the operation in FIG. 6 is finished.

The above operation is performed by each of the plurality of RSUs 1 directed to a plurality of directions, respectively. Accordingly, the primary fusion parts 12 of the plurality of RSUs 1 calculate a plurality of object regions based on object information in a plurality of directions, and the blind area calculation parts 122 of the plurality of RSUs 1 calculate a plurality of blind area regions based on a plurality of object regions.

Description of Transmission Information of RSU

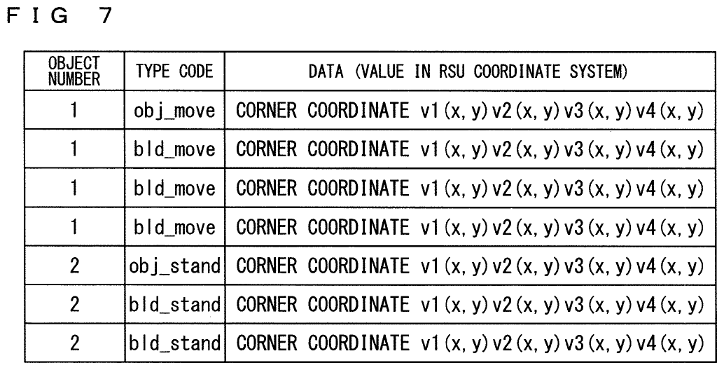

FIG. 7 is a drawing illustrating transmission information from the RSU 1 to the fusion server 2. Each column in a table in FIG. 7 indicates one of the object region and a quadrangular part of the blind area region.

A first column in the table in FIG. 7 indicates a number of each object detected by the RSU 1, that is an object number given to each object in one RSU 1. An object number of an object which is a source of an occurrence of the blind area is given to the blind area region. For example, in FIG. 5, when the object number “1” is given to the object region 62, the object number “1” is also given to the corresponding blind area region 72 formed of the three quadrangular shapes. In FIG. 5, when the object number “2” is given to the object region 61, the object number “2” is also given to the corresponding blind area region 71 formed of the two quadrangular shapes.

A second column in FIG. 7 indicates a type code of a region. A character string of obj_move indicates an object region of a moving object, and a character string of obj_stand indicates an object region of a stationary object. A character string of bld_move indicates a blind area region caused by a moving object, and a character string of bld_stand indicates a blind area region caused by a stationary object.

A third column in FIG. 7 indicates a corner coordinate of a quadrangular shape of each region. This coordinate value is a value of a coordinate system specific to each RSU 1.

The transmission information from each RSU 1 to the fusion server 2 includes not only the information in FIG. 7 but also the information of the position and the direction of the RSU 1 of the location part 13.

Configuration of Fusion Server

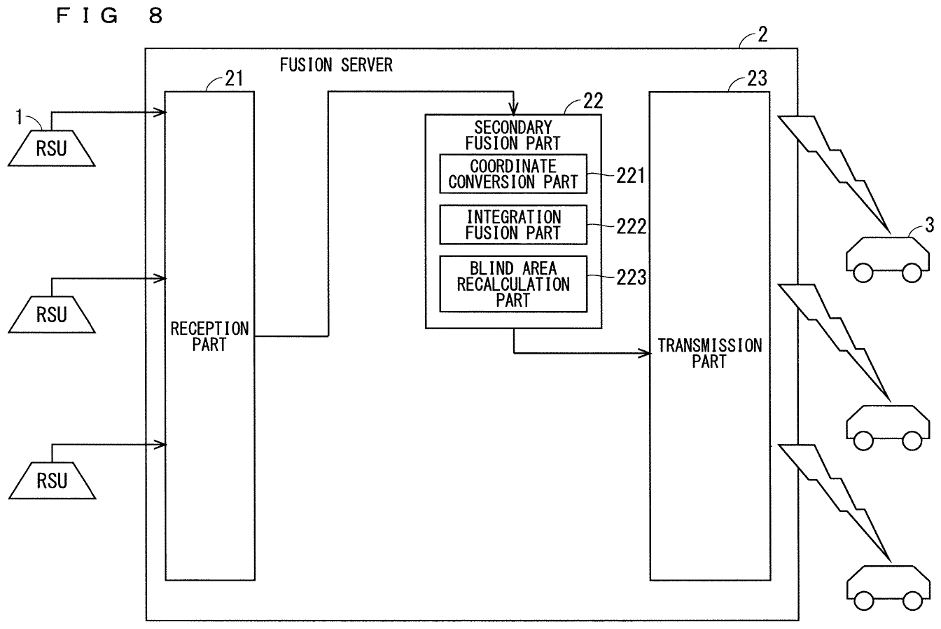

FIG. 8 is a block diagram illustrating a configuration of the fusion server 2 according to the present embodiment 1. The fusion server 2 in FIG. 8 includes a reception part 21, a secondary fusion part 22, and a transmission part 23.

The reception part 21 receives the object region and the blind area region in FIG. 7 from the plurality of RSUs 1. The reception part 21 synchronizes the plurality of RSUs 1 using a known technique.

The secondary fusion part 22 processes the transmission information from the plurality of RSUs 1. The secondary fusion part 22 includes a coordinate conversion part 221, an integration fusion part 222, and a blind area recalculation part 223. The coordinate conversion part 221 converts a coordinate system of the object region and the blind area region transmitted from the plurality of RSU 1 into an integrated global coordinate system based on the information of the position and the direction of the plurality of RSUs 1. The integration fusion part 222 integrates the object region from the plurality of RSUs 1, whose coordinate is converted in the coordinate conversion part 221. The blind area recalculation part 223 integrates the blind area region from the plurality of RSUs 1, whose coordinate is converted in the coordinate conversion part 221. The transmission part 23 transmits the integrated object region and blind area region to the automatic driving vehicle 3 in the generation target region including the integrated object region and blind area region. Accordingly, the object region and the blind area region of the RSU 1 is substantially transmitted to the automatic driving vehicle 3 in the generation target region.

Flow Chart of Fusion Server

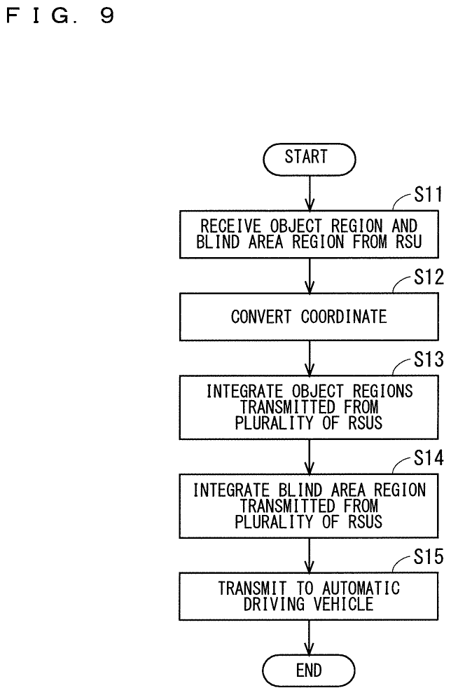

FIG. 9 is a flow chart illustrating an operation of the fusion server 2 according to the present embodiment 1. The fusion server 2 executes the operation illustrated in FIG. 9 every predetermined time period.

Firstly in Step S11, the reception part 21 receives the object region and the blind area region in FIG. 7 from the plurality of RSUs 1.

In Step S12, the coordinate conversion part 221 converts a coordinate system of the object region and the blind area region transmitted from the plurality of RSU 1 into an integrated global coordinate system in the plurality of RSUs 1 based on the information of the position and the direction of the plurality of RSUs 1.

In Step S13, the integration fusion part 222 performs fusion processing of integrating the object region transmitted from the plurality of RSUs 1 for each object 6. Performed in the fusion processing is, for example, OR processing of adding the object region transmitted from the plurality of RSUs 1 for each object 6.

In Step S14, the blind area recalculation part 223 performs fusion processing of integrating the blind area region transmitted from the plurality of RSUs 1 for each object 6. Performed in the fusion processing is, for example, AND processing of extracting a common part of the blind area region transmitted from the plurality of RSUs 1 for each object 6.

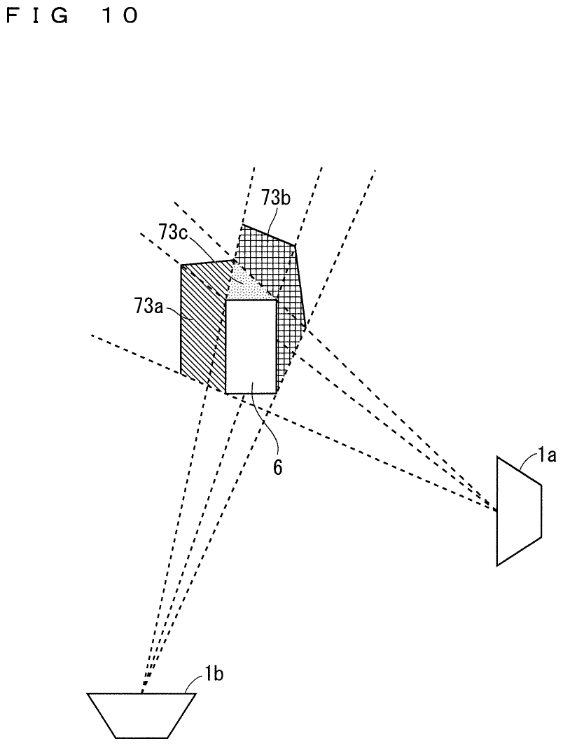

For example, as illustrated in FIG. 10, an RSU 1 a generates a blind area region 73a for the object 6, and an RSU 1b generates a blind area region 73b for the object 6. In this case, the blind area recalculation part 223 extracts a common part of the blind area regions 73a and 73b of the same object 6 in FIG. 10 as a blind area region 73c after the fusion. The blind area region 73c is a region which is a blind area in both the RSUs 1a and 1b.

In Step S15 in FIG. 9, the transmission part 23 transmits the integrated object region and blind area region to the automatic driving vehicle 3 in the generation target region including the integrated object region and blind area region. Subsequently, the operation in FIG. 9 is finished.

Configuration of Transmission Information of Fusion Server

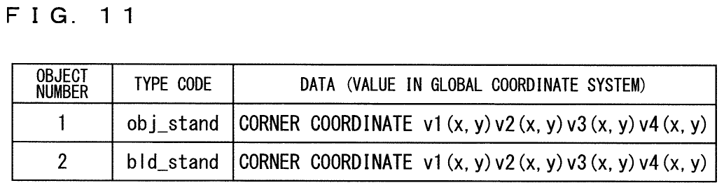

FIG. 11 is a drawing illustrating transmission information from the fusion server 2 to the automatic driving vehicle 3. Each column in a table in FIG. 11 indicates one of the integrated object region and blind area region.

A first column in the table in FIG. 11 indicates an object number given to each of the object region and the blind area region as one item regardless of a relationship between the object and the blind area. A second column in the table in FIG. 11 indicates a type code similar to the transmission information in FIG. 7. The type code may include a character string of obj_fix indicating the object region of a fixing body having a longer stationary time than the stationary object and a character string bld_fix indicating the blind area region caused by the fixing body. A third column in the table in FIG. 11 indicates a corner coordinate of each region similar to the transmission information in FIG. 7. However, a coordinate value in FIG. 11 is a value in an integrated global coordinate system in the plurality of RSUs 1. When the region corresponding to one row in FIG. 11 has a triangular shape, an invalid value may be set to v4, and when the region corresponding to one row in FIG. 11 has a pentagonal shape with five corners or has a shape with more corners, the region may be expressed by five or more coordinates.

Configuration of Vehicle-Side Control Device

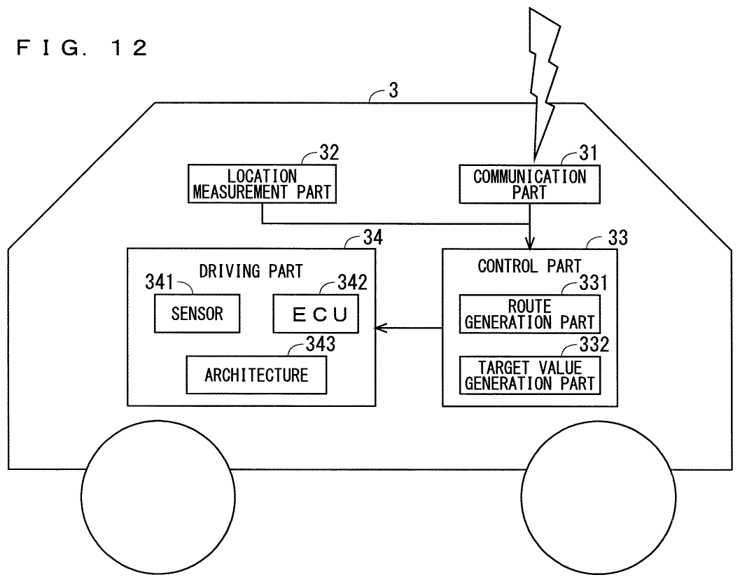

FIG. 12 is a block diagram illustrating a configuration of a vehicle-side control device provided in the automatic driving vehicle 3. The vehicle-side control device in FIG. 12 includes a communication part 31, a location measurement part 32, a control part 33, and a driving part 34. The automatic driving vehicle 3 in which the vehicle-side control device is provided is also referred to as “the subject vehicle” in some cases hereinafter.

The communication part 31 communicates with the fusion server 2. Accordingly, the communication part 31 receives the object region and the blind area region integrated by the fusion server 2.

The location measurement part 32 measures a position and a direction (for example, an orientation) of the subject vehicle in the manner similar to the location part 13 of the RSU 1 in FIG. 2. The position and the direction of the subject vehicle measured by the location measurement part 32 is expressed by a global coordinate system.

The control part 33 controls traveling of the subject vehicle based on the object region and the blind area region received by the communication part 31. The control part 33 includes a route generation part 331 and a target value generation part 332. The route generation part 331 generates and determines a traveling route along which the subject vehicle should travel based on the position of the subject vehicle measured by the location measurement part 32, a destination, the object region, the blind area region, and a map of the global coordinate system. The target value generation part 332 generates a control target value of a vehicle speed and a handle angle, for example, for the subject vehicle to travel along the traveling route generated by the route generation part 331.

The driving part 34 includes a sensor 341, an electronic control unit (ECU) 342, and an architecture 343. The ECU 342 drives the architecture 343 based on information around the subject vehicle detected by the sensor 341 and the control target value generated by the control part 33.

Flow Chart of Vehicle-Side Control System

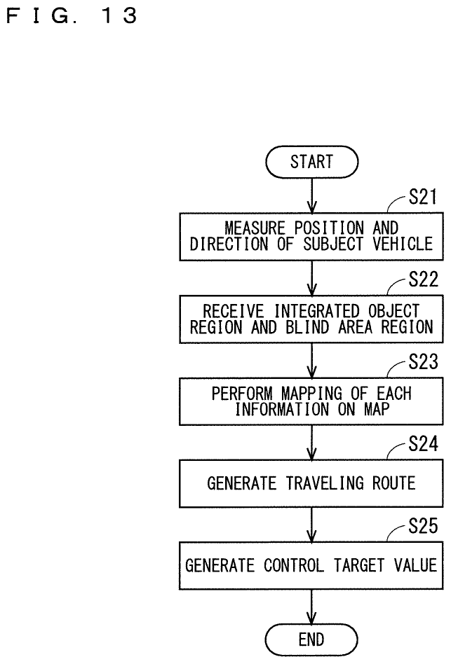

FIG. 13 is a flow chart illustrating an operation of the vehicle-side control device of the automatic driving vehicle 3 according to the present embodiment 1. The vehicle-side control device executes an operation illustrated in FIG. 13 every predetermined time period.

Firstly in Step S21, the location measurement part 32 measures and acquires the position and the direction of the subject vehicle.

In Step S22, the communication part 31 receives the object region and the blind area region integrated by the fusion server 2.

In Step S23, the route generation part 331 transcribes the position and the direction of the subject vehicle measured by the location measurement part 32, the destination, the object region, and the blind area region on the map of the global coordinate system to map them. The mapping in Step S23 can be easily performed by previously unifying all the coordinate values into the value of the global coordinate system.

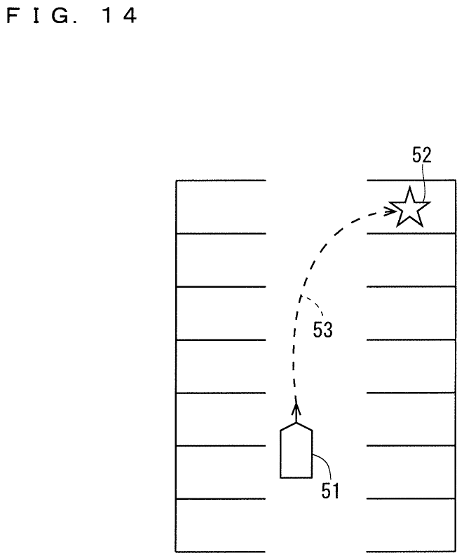

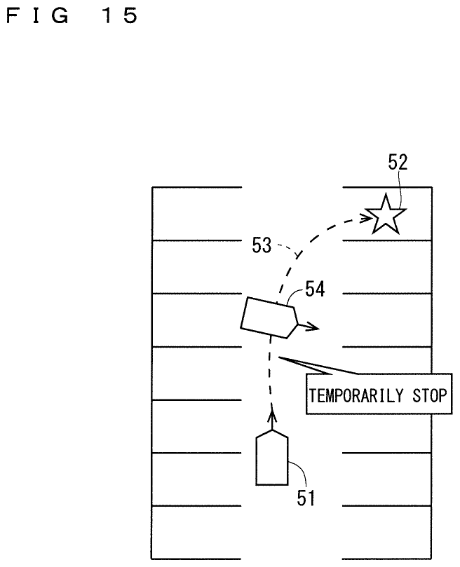

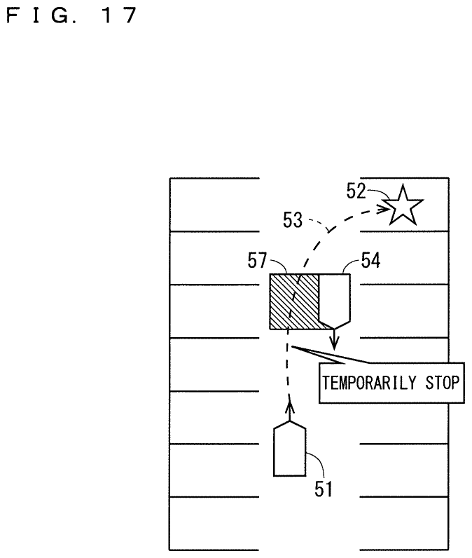

In Step S24, the route generation part 331 generates the traveling route along which the subject vehicle should travel based on the map on which the mapping has been performed. For example, firstly as illustrated in FIG. 14, the route generation part 331 generates, as a temporary route 53, a route along which the subject vehicle 51 can reach a destination 52 in a shortest distance from the position and the direction of the subject vehicle 51 measured by the location measurement part 32. In the example in FIG. 14, the destination 52 is a spot in a parking space, however, the configuration is not limited thereto. The route generation part 331 reflects the object region and the blind area region in the temporary route 53 to generate the traveling route. This configuration is described using FIG. 15 to FIG. 18 hereinafter.

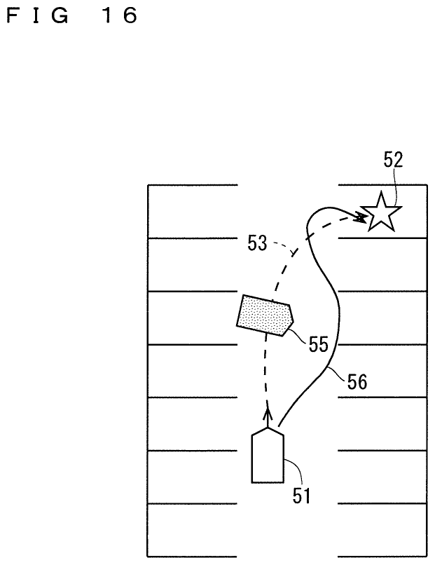

In a case where an object region 54 of a moving object is located on the temporary route 53 as illustrated in FIG. 15, the route generation part 331 generates a traveling route for the subject vehicle to temporarily stop in front of the object region 54 of the moving object and to start traveling when the object region is out of front of the subject vehicle 51. In a case where an object region 55 of a stationary object is located on the temporary route 53 as illustrated in FIG. 16, the route generation part 331 generates the traveling route 56 for the subject vehicle to avoid the object region 55 of the stationary object.

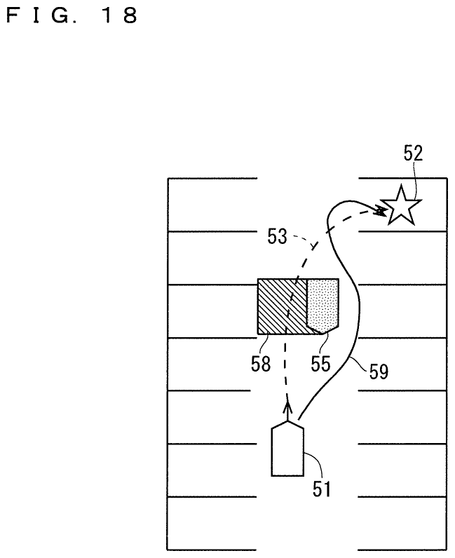

In a case where a blind area region 57 of a moving object is located on the temporary route 53, the route generation part 331 generates a traveling route for the subject vehicle to temporarily stop in front of the blind area region 57 of the moving object and to start traveling when the blind area region 57 is out of front of the subject vehicle 51. In a case where a blind area region 58 of a stationary object is located on the temporary route 53 as illustrated in FIG. 18, the route generation part 331 generates the traveling route 59 for the subject vehicle to avoid the object region 55 of the stationary object and the blind area region 58.

When there are a plurality of regions including the object region and the blind area region between the subject vehicle and the destination, the route generation part 331 generates a traveling route satisfying the conditions of FIG. 15 to FIG. 18 for all of the regions as a final traveling route. The subject vehicle temporarily stops in front of the object region and the blind area region of the moving object, and then the operation in the flow chart in FIG. 13 is periodically executed, thus the subject vehicle starts traveling again in accordance with a movement of the object region and the blind area region of the moving object.

In Step S25 in FIG. 13, the target value generation part 332 generates a control target value based on the traveling route generated in the route generation part 331. Subsequently, the operation in FIG. 13 is finished.

Conclusion of Embodiment 1

According to the present embodiment 1 described above, the RSU 1 acquires the object region of the object and estimates the blind area region of the object. According to such a configuration, even when the automatic driving vehicle 3 does not include a sensor, the automatic driving vehicle 3 can grasp the object region and the blind area region of the object located around the automatic driving vehicle 3, for example. Thus, even when the automatic driving vehicle 3 does not include a sensor, the automatic driving vehicle 3 can plan a traveling route suppressing a collision with the object and a collision with an obstacle in the blind area region based on the object region and the blind area region. It is estimated whether the blind area region is a region of a blind area caused by a moving object or a stationary object, thus the automatic driving vehicle 3 can plan an appropriate traveling route by a type of an object, for example.

### Modification Example

In the embodiment 1, the detection part 11 of the RSU 1 in FIG. 2 includes the three types of sensors of the camera 11, the radio wave radar 112 and the laser radar 113, but may include the other sensor to acquire a necessary object region and blind area region.

In the embodiment 1, the primary fusion part 12 is included in the RSU 1 in FIG. 2, however, this configuration is not necessary. For example, the primary fusion part may be included in the fusion server 2, or may be provided in a constituent element different from the RSU 1 and the fusion server 2. In this case, the primary fusion part 12 can be omitted from the configuration of the RSU 1, and moreover, the calculation of the object region in Step S2 and the calculation of the blind area region in Step S3 can be omitted from the flow chart of the RSU 1 in FIG. 6.

In the embodiment 1, various types of GNSS are used as the location part 13 in FIG. 2, however, this configuration is not necessary. For example, in a case of a stationary type RSU 1, the location part 13 may be a memory for fixed location in which the GNSS is not mounted but a position and a direction of the RSU 1 are stored. The memory for fixed location may be incorporated into the communication part 14, the primary fusion part 12, or the detection part 11. The location part 13 may include an acceleration sensor and a gyro sensor to measure an oscillation caused by a strong wind.

### Embodiment 2

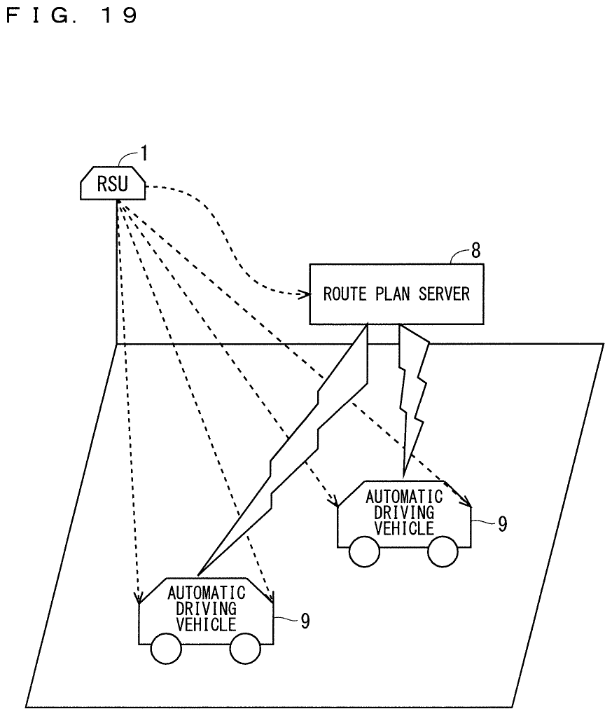

FIG. 19 is a drawing illustrating a vehicle travel system according to the present embodiment 2. The same or similar reference numerals as those described above will be assigned to the same or similar constituent elements according to the present embodiment 2, and the different constituent elements are mainly described hereinafter.

In the embodiment 1, the fusion server 2 transmits the object region and the blind area region to the automatic driving vehicle 3, and the automatic driving vehicle 3 generates the traveling route and the control target value based on the object region and the blind area region. In contrast, in the present embodiment 2, a route plan server 8 which is a travel pattern generation device determines a travel pattern of an automatic driving vehicle 9 in the generation target region based on the object region and the blind area region transmitted from the plurality of RSUs 1, and transmits the travel pattern to the automatic driving vehicle 9. The travel pattern is a travel pattern for performing a traveling along the traveling route 56 described in the embodiment 1, and is substantially the same as the traveling route 56. The automatic driving vehicle 9 generates the control target value based on the travel pattern received from the route plan server 8, and travels based on the control target value. The automatic driving of the automatic driving vehicle 9 may be an automatic driving of autonomous driving (AD) control or an automatic driving of advanced driver assistance system (ADAS) control.

Configuration of RSU

A configuration of the RSU 1 according to the present embodiment 2 is similar to the configuration of the RSU 1 according to the embodiment 1.

Configuration of Route Plan Server

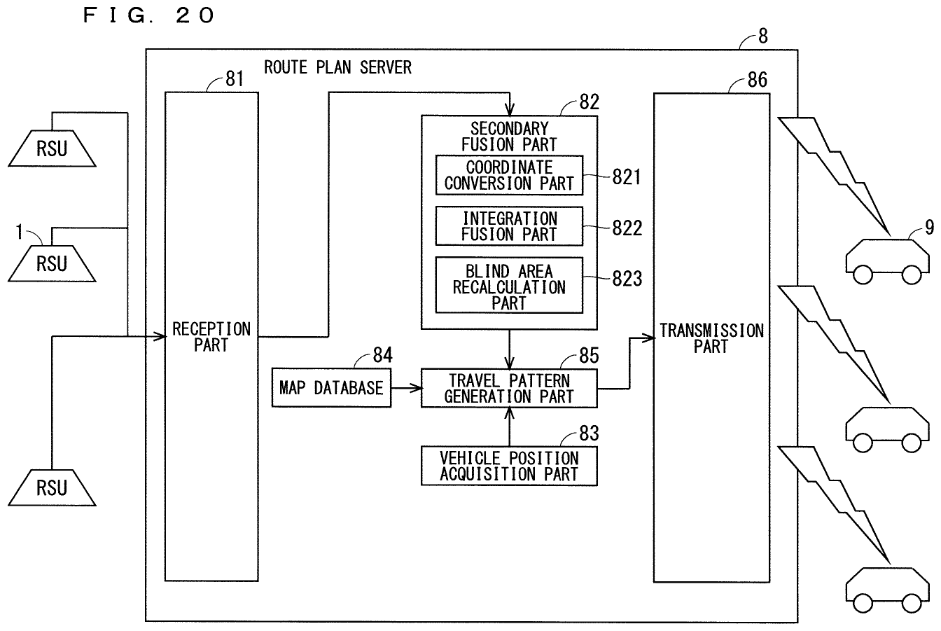

FIG. 20 is a block diagram illustrating a configuration of the route plan server 8 according to the present embodiment 2. The route plan server 8 in FIG. 20 includes a reception part 81, a secondary fusion part 82, a vehicle position acquisition part 83, a map database 84, a travel pattern generation part 85, and a transmission part 86.

The reception part 81 receives transmission information, for example, from the plurality of RSUs 1 in the manner similar to the reception part 21 in the embodiment 1.

The secondary fusion part 82 includes a coordinate conversion part 821, an integration fusion part 822, and a blind area recalculation part 823 similar to the coordinate conversion part 221, the integration fusion part 222, and the blind area recalculation part 223 in the embodiment 1, respectively. The secondary fusion part 82 having such a configuration integrates the object regions transmitted from the plurality of RSUs 1, and integrates the blind area regions transmitted from the plurality of RSUs 1 in the manner similar to the secondary fusion part 22 in the embodiment 1.

For example, the vehicle position acquisition part 83 communicates with each automatic driving vehicle 9 in the generation target region, thereby sequentially acquiring a position, an orientation, and a destination of each automatic driving vehicle 9 in each automatic driving vehicle 9. The map database 84 stores a map of a global coordinate system in the generation target region.

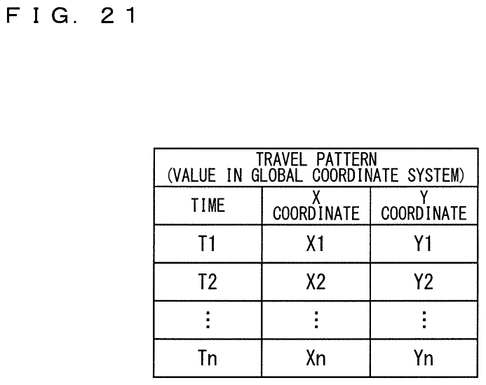

The travel pattern generation part 85 performs processing similar to that performed by the route generation part 331 included in the automatic driving vehicle 3 in the embodiment 1. Specifically, the travel pattern generation part 85 generates and determines a travel pattern of the automatic driving vehicle 9 based on the position, the orientation, and the destination of the automatic driving vehicle 9 acquired by the vehicle position acquisition part 83, the object region and the blind area region integrated by the secondary fusion part 82, and the map of the map database 84. The transmission part 86 transmits the travel pattern including a list of a time and a target position to the automatic driving vehicle 9. FIG. 21 is a drawing illustrating the list of the time and the target position transmitted from the route plan server 8 to the automatic driving vehicle 9. The target position is indicated by an XY coordinate of a global coordinate system.

Flow Chart of Route Plan Server

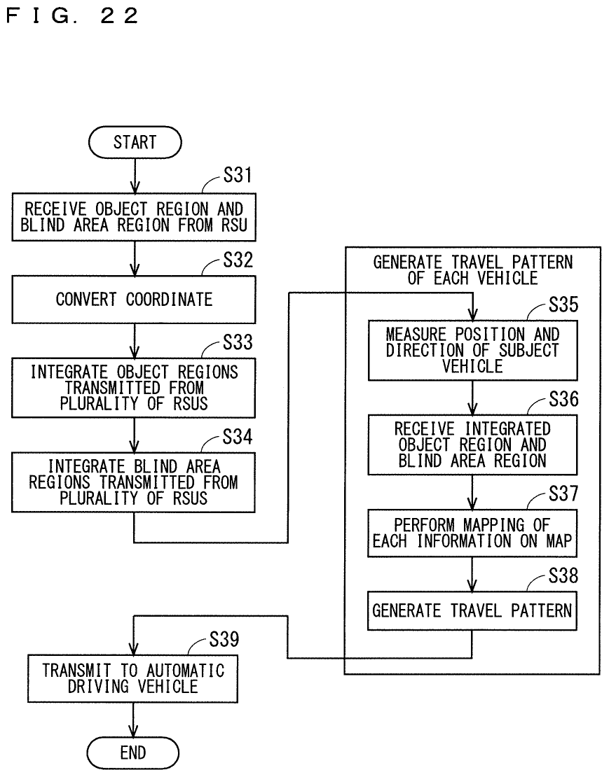

FIG. 22 is a flow chart illustrating an operation of the route plan server 8 according to the present embodiment 2. The route plan server 8 executes the operation illustrated in FIG. 22 every predetermined time period.

In Step S31 to Step S34, the route plan server 8 perforins processing similar to the processing of receiving the transmission information in Step S11 to the processing of integrating the blind area region in Step S14 in FIG. 9.

In Step S35 to Step S38, the route plan server 8 performs processing similar to the processing of acquiring the position and the orientation of the direction of the subject vehicle in Step S21 to the processing of generating the traveling route in Step S24 in FIG. 13. That is to say, in the present embodiment 2, in Step S38, the route plan server 8 generates a travel pattern for the automatic driving vehicle 9 to travel along the traveling route in the manner similar to the traveling route in Step S24. Accordingly, the travel pattern for traveling along the traveling route described in FIG. 15 to FIG. 18 is generated.

For example, when the blind area region is estimated to be a region of a blind area caused by an stationary object, the route plan server 8 determines a travel pattern for the automatic driving vehicle 9 to avoid the blind area region. For example, when the blind area region is estimated to be a region of a blind area caused by a moving object, the route plan server 8 determines a travel pattern for the automatic driving vehicle 9 to stop in front of the blind area region and to starts traveling when the blind area region is out of front of the automatic driving vehicle 9.

In Step S39, the route plan server 8 transmits the travel pattern to the automatic driving vehicle 9. Subsequently, the operation in FIG. 22 is finished.

Configuration of Automatic Driving Vehicle

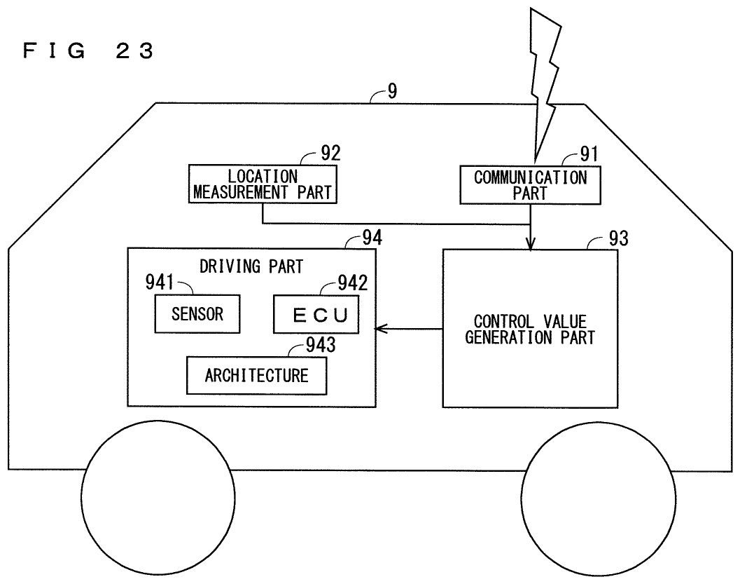

FIG. 23 is a block diagram illustrating a configuration of a vehicle-side control device provided in the automatic driving vehicle 9. The vehicle-side control device in FIG. 23 includes a communication part 91, a location measurement part 92, a control value generation part 93, and a driving part 94.

The communication part 91 communicates with the route plan server 8. Accordingly, the communication part 91 receives the travel pattern generated by the route plan server 8. The location measurement part 92 measures a position and a direction of the subject vehicle in the manner similar to the location measurement part 32 in the embodiment 1.

The control value generation part 93 generates a control target value of a vehicle speed and a handle angle, for example, based on the travel pattern received by the communication part 91 and the position and the orientation of the subject vehicle measured by the location measurement part 92.

The driving part 94 includes a sensor 941, an ECU 942, and an architecture 943. The ECU 942 drives the architecture 943 based on information around the subject vehicle detected by the sensor 941 and the control target value generated by the control value generation part 93.

Conclusion of Embodiment 2

According to the present embodiment 2 described above, the route plan server 8 can grasp the object region and the blind area region of the object located around each automatic driving vehicle 9. Accordingly, even when the automatic driving vehicle 9 does not include a sensor and a route generation part, the route plan server 8 can plan a travel pattern for suppressing a collision between the automatic driving vehicle 9 and an object, for example, based on the object region and the blind area region. It is estimated whether the blind area region is a region of a blind area caused by a moving object or a stationary object, thus the automatic driving vehicle 9 can plan an appropriate travel pattern by a type of an object, for example.

### Another Modification Example

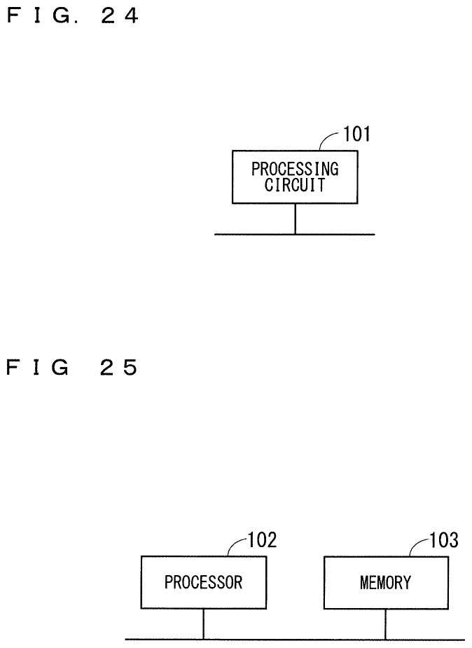

The acquisition part and the estimation part described as the object fusion part 121 and the blind area calculation part 122 in FIG. 2, respectively, are referred to as “the acquisition part etc.” hereinafter. The acquisition part etc. is achieved by a processing circuit 101 illustrated in FIG. 24. That is to say, the processing circuit 101 includes: an acquisition part acquiring an object region which is a region of an object based on object information which is information of the object in a predetermined region detected by a detection part; and an estimation part estimating a blind area region which is a region of a blind area for the detection part caused by the object based on the object region. Dedicated hardware may be applied to the processing circuit 101, or a processer executing a program stored in a memory may also be applied. Examples of the processor include a central processing unit, a processing device, an arithmetic device, a microprocessor, a microcomputer, or a digital signal processor (DSP).

When the processing circuit 101 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 101. Each function of each part of the acquisition part etc. may be achieved by circuits to which the processing circuit is dispersed, or each function of them may also be collectively achieved by one processing circuit.

When the processing circuit 101 is the processor, the functions of the acquisition part etc. are achieved by a combination with software etc. Software, firmware, or software and firmware, for example, fall under the software etc. The software etc. is described as a program and is stored in a memory. As illustrated in FIG. 25, a processor 102 applied to the processing circuit 101 reads out and executes a program stored in the memory 103, thereby achieving the function of each unit. That is to say, the blind area estimation device includes a memory 103 for storing the program to resultingly execute steps of: acquiring an object region which is a region of an object based on object information which is information of the object in a predetermined region detected by a detection part; and estimating a blind area region which is a region of a blind area for the detection part caused by the object based on the object region. In other words, this program is also deemed to make a computer execute a procedure or a method of the acquisition part etc. Herein, the memory 103 may be a non-volatile or volatile semiconductor memory such as a random access memory (RAM), a read only memory (ROM), a flash memory, an electrically programmable read only memory (EPROM), or an electrically erasable programmable read only memory (EEPROM), a hard disk drive

(HDD), a magnetic disc, a flexible disc, an optical disc, a compact disc, a mini disc, a digital versatile disc (DVD), or a drive device of them, or any storage medium which is to be used in the future.

Described above is the configuration that each function of the acquisition part etc. is achieved by one of the hardware and the software, for example. However, the configuration is not limited thereto, but also applicable is a configuration of achieving a part of the acquisition part etc. by dedicated hardware and achieving another part of them by software, for example. For example, the function of the acquisition part can be achieved by the processing circuit 101 as the dedicated hardware, an interface, and a receiver, for example, and the function of the other units can be achieved by the processing circuit 101 as the processor 102 reading out and executing the program stored in the memory 103.

As described above, the processing circuit 101 can achieve each function described above by the hardware, the software, or the combination of them, for example. Each embodiment and each modification example can be arbitrarily combined, or each embodiment and each modification example can be appropriately varied or omitted.

While the invention has been shown and described in detail, the foregoing description is in all aspects illustrative and not restrictive. It is therefore understood that numerous modifications and variations can be devised without departing from the scope of the invention.

What is claimed is:

1. A blind area estimation apparatus, comprising:
a receiver acquiring an object region which is a region of an object based on object information which is information of the object in a predetermined region detected by a detector; and
an estimation circuitry estimating a blind area region which is a region of a blind area for the detector caused by the object based on the object region.

2. The blind area estimation apparatus according to claim 1, wherein
the receiver acquires a plurality of object regions based on the object information in a plurality of directions,
the estimation circuitry estimates a plurality of blind area regions based on the plurality of object regions, and extracts a common part of the plurality of blind area regions.

3. The blind area estimation apparatus according to claim 1, wherein
the object includes a moving object and a stationary object, and
it is estimated whether the blind area region is a region which is the blind area caused by the moving object or a region which is the blind area caused by the stationary object.

4. The blind area estimation apparatus according to claim 1, wherein
the object region and the blind area region are transmitted to an automatic driving vehicle in the predetermined region.

5. The blind area estimation apparatus according to claim 3, wherein
the object region and the blind area region are transmitted to an automatic driving vehicle in the predetermined region.

6. A vehicle travel system, comprising:
the blind area estimation apparatus according to claim 4; and
the automatic driving vehicle, wherein
the automatic driving vehicle determines a traveling route of the automatic driving vehicle based on the object region and the blind area region.

7. A vehicle travel system, comprising:
the blind area estimation apparatus according to claim 5; and
the automatic driving vehicle, wherein
the automatic driving vehicle determines a traveling route of the automatic driving vehicle based on the object region and the blind area region.

8. The vehicle travel system according to claim 7, wherein
the automatic driving vehicle determines the traveling route for the automatic driving vehicle to avoid the blind area region when the blind area region is estimated to be a region which is the blind area caused by the stationary object.

9. The vehicle travel system according to claim 7, wherein
when the blind area region is estimated to be a region which is the blind area caused by the moving object, the automatic driving vehicle determines the traveling route for the automatic driving vehicle to stop in front of the blind area region on the traveling route and to start traveling when the blind area region is out of front of the automatic driving vehicle.

10. A vehicle travel system, comprising:
the blind area estimation apparatus according to claim 1;
an automatic driving vehicle traveling based on a travel pattern; and
a travel pattern generation apparatus determining the travel pattern of the automatic driving vehicle in the predetermined region based on the object region and the blind area region.

11. A vehicle travel system, comprising:
the blind area estimation apparatus according to claim 3;
an automatic driving vehicle traveling based on a travel pattern; and
a travel pattern generation apparatus determining the travel pattern of the automatic driving vehicle in the predetermined region based on the object region and the blind area region.

12. The vehicle travel system according to claim 11, wherein the travel pattern generation apparatus determines the travel pattern for the automatic driving vehicle to avoid the blind area region when the blind area region is estimated to be a region which is the blind area caused by the stationary object.

13. The vehicle travel system according to claim 11, wherein
when the blind area region is estimated to be a region which is the blind area caused by the moving object, the travel pattern generation apparatus determines the travel pattern for the automatic driving vehicle to stop in front of the blind area region and to start traveling when the blind area region is out of front of the automatic driving vehicle.

14. A blind area estimation method, comprising:
acquiring an object region which is a region of an object based on object information which is information of the object in a predeten tined region detected by a detector; and
estimating a blind area region which is a region of a blind area for the detector caused by the object based on the object region.
